(19) United States
(12) Patent Application Publication
(10) Pub. No.: US 2005/0213833 A1
(43) Pub. Date: Sep. 29, 2005

(54) Image processing device and method for displaying images on multiple display devices

(75) Inventors: Shigeyuki Okada, Ogaki-shi (JP); Noriaki Kojima, Ogaki-shi (JP); Shinichiro Okada, Toyohashi-shi (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/078,397

(22) Filed: Mar. 14, 2005

(30) Foreign Application Priority Data
Mar. 29, 2004 (JP) 2004-094448

(51) Int. Cl. G06K 9/36

(52) U.S. Cl. 382/240

(57) ABSTRACT

A decoding unit 150 decodes coded image data. A low resolution frame buffer 30 stores low resolution image data output from the decoding unit 150. A high resolution frame buffer 40 stores high resolution image data output from the decoding unit 150. A low resolution display circuit 32 acquires data from the low resolution frame buffer 30, and creates display signals for a low resolution display device 36 for displaying low resolution moving images. A high resolution display circuit 42 acquires data from the high resolution frame buffer 40, and creates display signals for a high resolution display device 46 for displaying high resolution moving images. Thus, each of multiple display devices can display respective moving images with different resolution.

### BACKGROUND OF THE INVENTION

1. Field of the Invention

The present invention relates to an image processing device and an image processing method.

2. Description of the Related Art

The falling prices of liquid crystal displays and plasma displays, due to improvement of manufacturing techniques for such thin displays, are speeding the spread of various display devices with various sizes for displaying moving images. Nowadays, there are various kinds of display devices with various resolutions such as liquid crystal displays for cellular phones or large-size high resolution displays. Each display device decodes a coded image data stream to display moving images corresponding to the resolution of the display device itself.

As an example of such techniques, a moving-image reproduction processing device is disclosed in Japanese Unexamined Patent Application Publication No. 2002-94994, which has a function for performing decoding process with a resolution corresponding to the display size. The device includes multiple decoding process units, each of which compares the display size and the size of the original image and decodes the original images into images with a resolution corresponding to the display size. The moving-image reproduction processing device enables various kinds of display devices having different resolutions to display moving images using a single kind of coded image data stream.

It is assumed that, in the near future, increase of digital distribution of video contents will require display of multiple sets of moving images with different resolutions at the same time using a single kind of data stream. However, with such a technique described above, a decoding process unit outputs images with a single resolution selected by a resolution selection processing unit, i.e., such a moving-image reproduction processing device has no function for outputting multiple sets of moving images with different resolutions for multiple display devices using a single kind of coded image data stream. Furthermore, the decoding process unit has just a function for outputting moving images with one of predetermined kinds of resolutions prepared beforehand.

### SUMMARY OF THE INVENTION

The present invention has been made in view of the above problems, and accordingly, it is an object thereof to provide a device for displaying multiple sets of moving images with different resolutions on multiple display devices.

According to one aspect of the invention, a decoding unit decodes coded image data so as to create multiple sets of moving images with different resolutions for displaying said moving images on a plurality of display devices. Thus, each of a low resolution display device and a high resolution display device may display moving images with the corresponding resolution using a single set of coded image data.

The image processing device may create moving images with a lower resolution than that of completely decoded images, using intermediate images obtained in a decoding process for decoding the coded image data. By using intermediate decoded images obtained in the decoding process, a processing load of the image processing device may be reduced as compared with a conventional method wherein decoding process is performed for the resolution required for each display device. Note that “intermediate image” used herein refers to an image obtained in an intermediate step in the decoding process for creating the completely decoded image, and corresponds to “LL subband image” described in the following embodiments.

Another aspect of the invention relates to an image processing device. The image processing device comprises: a decoding unit for decoding coded image data; a low resolution frame buffer for storing low resolution image data output from said decoding unit; a high resolution frame buffer for storing high resolution image data output from said decoding unit; a low resolution display circuit for acquiring data from said low resolution frame buffer and creating display signals for a low resolution display device; and a high resolution display circuit for acquiring data from said high resolution frame buffer and creating display signals for a high resolution display device. According to the aspect, the decoding unit decodes a coded image data stream into low resolution image data and high resolution image data, and distributes the low resolution image data and the high resolution image data to the corresponding frame buffers. Thus, the image processing device enables each display device to display moving images with the corresponding resolution.

At least one of said low resolution display circuit and said high resolution display circuit has a converter for performing resolution conversion. Using the converter, the display device may display moving images with even a resolution which cannot be directly obtained by decoding the coded image data.

The coded image data is multiplexed in regard to resolution. As an example, coded image data adherence to Motion-JPEG 2000 is employed, wherein image data is compressed for each frame and can be continuously transmitted. With such a data structure, the coded image data is multiplexed in regard to the resolution and accordingly an intermediate image obtained in the decoding process may be used as a low resolution image.

The image processing device may further comprise a memory control unit for controlling data writing to said low resolution frame buffer and said high resolution frame buffer. Furthermore, the memory control unit may control each of the low resolution frame buffer and the high resolution frame buffer to store images with the corresponding resolution, the images being created by decoding the coded image data. According to the aspect, the memory control unit acquires intermediate decoded image data of a predetermined level or completely decoded image data based on the resolution information regarding the moving images to be displayed on the low resolution display device or the high resolution display device connected to the image processing device. Then the memory control unit writes the acquired image data to the corresponding frame buffer. Thus, two data sets, i.e., the low resolution image data and the high resolution image data may be acquired from a single set of the coded image data.

Note that the image processing device has single decoding unit. The image processing device may create multiple sets of image data having different resolutions by a single decoding unit effectively.

Another aspect of the present invention relates to an image processing method. The method comprises decoding coded image data by a decoding unit; extracting multiple sets of images with various resolutions from the decoded data; and outputting said multiple sets of images to multiple sets of display means through corresponding path. According to the aspect, by decoding a coded image data stream by the decoding unit, low resolution moving images and high resolution moving images may be displayed on the corresponding display devices. Note that there exists single decoding unit.

According to another aspect of the invention, the image processing device comprises: a decoding unit for decoding coded image data so as to create multiple sets of moving images with various resolutions for displaying the moving images on multiple display devices; and a region specifying unit for specifying region of interest on a screen, wherein said decoding unit decodes images having said region of interest with image quality different from that of an ordinary region other than said region of interest. In this case, when a user specifies the region of interest on one of the display devices, all the display devices display images having the region of interest with increased image quality. Thereby the audience of the display devices may be impressed with the importance of the image.

It would be appreciated that any combinations of the foregoing components, and expressions of the present invention having their methods, apparatuses, systems, recording media, computer programs, and the like converted mutually are also intended to constitute applicable aspects of the present invention.

This summary of the invention does not describe all necessary features so that the invention may also be a sub-combination of these described features.

### BRIEF DESCRIPTION OF THE DRAWINGS

FIG. 1 shows a procedure of image coding process;

FIG. 2 shows an image processing device according to a first embodiment of the invention;

FIG. 3 shows a procedure of image decoding process;

FIG. 4 illustrates processing for each frame performed by the image processing device;

FIG. 5 is a flowchart of the process performed by a memory control unit;

FIG. 6 shows an image processing device according to a second embodiment of the invention;

FIG. 7 shows an image processing device according to a third embodiment of the invention;

FIGS. 8A, 8B and 8C are diagrams for describing masks for specifying wavelet transformation coefficients corresponding to the region of interest specified in an original image;

FIGS. 9A and 9B are diagrams for describing zero-substitution performed for the lower bits of the wavelet transformation coefficient;

FIGS. 10A, 10B and 10C are diagrams for describing wavelet transformation coefficients in case of specifying the region of interest in an original image;

FIG. 11 is a flowchart of the process performed by a determination unit;

FIGS. 12A and 12B are diagrams which show processing for reproducing an image with the region of interest of increased image quality;

FIGS. 13A, 13B and 13C are diagrams which show processing wherein the lower bits of the wavelet transformation coefficient are set to zero, for handling a situation wherein the region of interest is specified in an original image, and the necessary processing amount is excessively great;

FIG. 14 is a flowchart for describing another example of processing performed by the determination unit;

FIGS. 15A and 15B are diagrams which show processing for reproducing images with the region of interest of increased image quality, and with the ordinary region of reduced image quality;

FIGS. 16A and 16B are diagrams which show processing for reproducing images with the ordinary region of reduced image quality while maintaining the image quality of the region of interest;

FIG. 17 shows an image display device according to a fourth embodiment; and

FIG. 18 shows an image display system according to a fifth embodiment.

### DETAILED DESCRIPTION OF THE INVENTION

The present invention relates to a technique for creating multiple sets of moving images with different resolutions or different image qualities, using a single kind of coded image data stream. In the embodiments according to the present invention, description will be made regarding an image processing device having an image processing function for decoding a coded image data stream adherence to Motion-JPEG 2000.

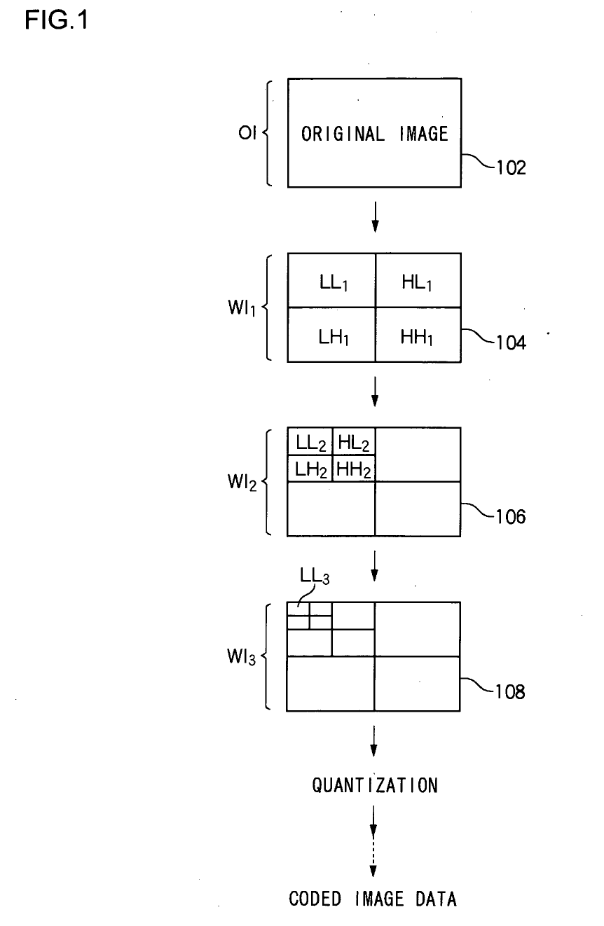

With reference to FIG. 1, description will be made in brief regarding a method for coding moving images in the format of Motion-JPEG 2000. An image coding device (not shown) continuously performs coding of each frame of the moving images, thereby creating a coded data stream of the moving images. An original image (OI 102), which is one frame of the moving images, is read out and stored in a frame buffer. The original image OI stored in the frame buffer is transformed into multiple component images in a hierarchical manner by a wavelet transformation unit.

The wavelet transformation unit adherence to JPEG 2000 employs a Daubechies filter. This filter serves as both a high-pass filter and a low-pass filter at the same time in both X direction and Y direction, thereby transforming a single image into four frequency subband images. These subband images consist of: an LL subband image having a low-frequency component in both X direction and Y direction; an HL subband image and an LH subband image having a low-frequency component in one direction and a high-frequency component in other direction; and an HH subband image having a high-frequency component in both X direction and Y direction. Furthermore, the aforementioned filter has a function for halving the number of the pixels in both X direction and Y direction. Thus, each subband image is formed with half the number of the pixels in both the X direction and the Y direction as compared with the image before the processing performed by the wavelet transformation unit. That is to say, each original image is transformed into subband images by single filtering, each of which is the quarter image size of that of the original image. Hereafter, the image into which the original image OI is transformed by one-time wavelet transformation will be referred to as “first level image WI₁”. In the same way, the image into which the original image OI is transformed by n-time wavelet transformation will be referred to as “n-th level image WIₙ”.

As shown in FIG. 1, the original image OI is transformed into the first level image WI₁ 104 which consists of the four subband images LL₁, HL₁, LH₁, and HH₁. Next, the first level image WI₁ 104 is further subjected to wavelet transformation, thereby creating a second level image WI₂ 106. Note that the second or further wavelet transformation is performed only for the LL subband image of the immediately preceding level. Accordingly, the LL₁ subband image of the first level image WI₁ is transformed into four subband images LL₂, HL₂, LH₂, and HH₂, whereby a second level image WI₂ 106 is created. The wavelet transformation unit performs such filtering a predetermined number of times, and outputs wavelet transformation coefficients for each subband image. The image coding device further performs subsequent processing such as quantization processing and so forth, and outputs a coded image data CI (Coded Images) in the final stage.

For the sake of simplicity, the image coding device performs wavelet transformation to the original image OI three times. Assume that the original image OI 102 is formed with an image size of 1440×960 pixels. In this case, the first level image WI₁ 104 includes the subband image LL₁ with an image size of 720×480, the second level image WI₂ 106 includes the subband image LL₂ with an image size of 360×240, and the third level image WI₃ 108 includes the subband image LL₃ with an image size of 180×120.

It should be noted that the closer to the upperleft corner of the image, the lower frequency component of the original image OI the subband image has. In an example shown in FIG. 1, the LL₃ subband image at the upperleft corner of the third level image WI₃ has the lowest frequency component. That is to say, the most basic image properties of the original image OI can be reproduced using LL₃ subband image alone. Note that the following embodiments are realized based upon the aforementioned fact.

Examples of such a coded data stream, which may be employed in the embodiments according to the present invention, include Motion-JPEG, or SVC (Scalable Video Codec), wherein a single stream has both a high image-quality HD stream and a low image-quality SD stream, as well as Motion-JPEG 2000 described above. In case of employing the JPEG, each frame is transmitted from a lower order of Fourier coefficient, thereby allowing selection of the image quality by determining the highest order of the Fourier coefficient used for decoding.

### First Embodiment

An image processing device according to a first embodiment has a function for providing moving images with different resolutions to multiple display devices using a received coded image data stream multiplexed in regard to resolution.

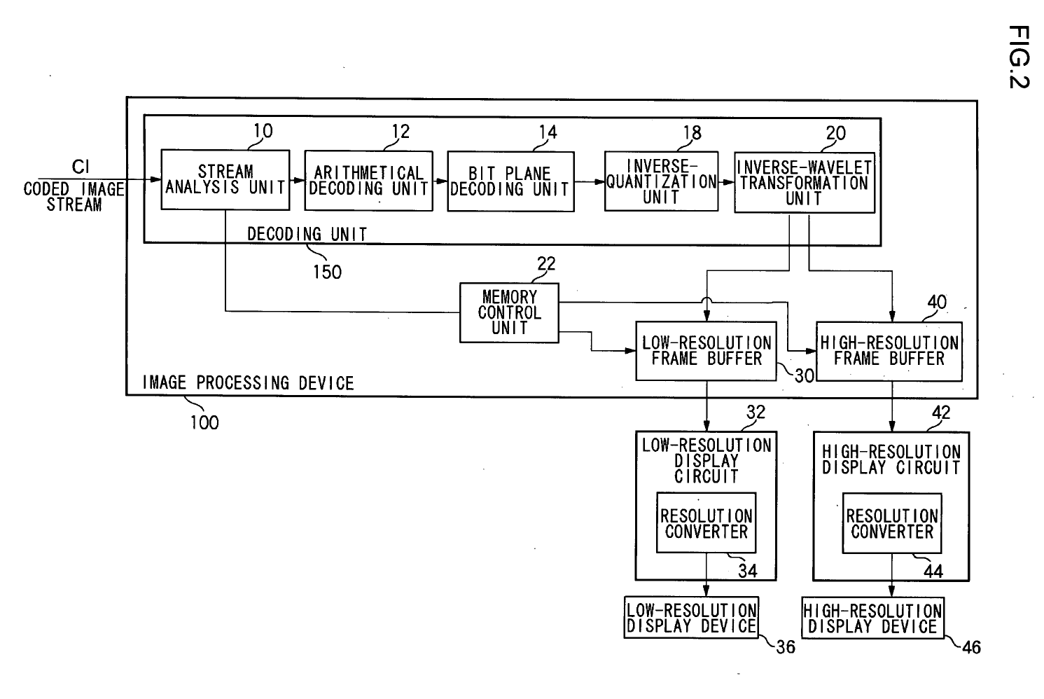

FIG. 2 shows an image processing device 100 according to the first embodiment. Such configuration can be realized by hardware means such as CPUs, memory, and other LSIs. Also, such configuration can be realized by software means such as a program having a decoding function. FIG. 2 shows a functional block diagram which may be implemented by a combination of hardware means and software means. It should be appreciated by those skilled in the art that the configuration shown in the functional block diagram can be realized by hardware means alone, software means alone, or various combinations of hardware means and software means.

A stream of coded image data CI is input to a decoding unit 150 of the image processing device 100. The decoding unit 150 includes: a stream analysis unit 10 for receiving the coded image data CI and analyzing the data stream; an arithmetical decoding unit 12 for performing arithmetical decoding process to the data sequence which has been determined to be decoded as a result of analysis performed; a bit plane decoding unit 14 for decoding the data, obtained by the aforementioned arithmetical decoding, in the form of bit-plane images for each color component; an inverse-quantization unit 18 for performing inverse-quantization to the quantized data obtained by decoding; and an inverse wavelet transformation unit 20 for performing inverse wavelet transformation to the n-th level image WIₙ obtained by inverse quantization. With such a configuration, an immediately higher level image is obtained for each inverse wavelet transformation of the coded image data CI performed by the inverse wavelet transformation unit 20, thereby obtaining a decoded image data DI in the final stage.

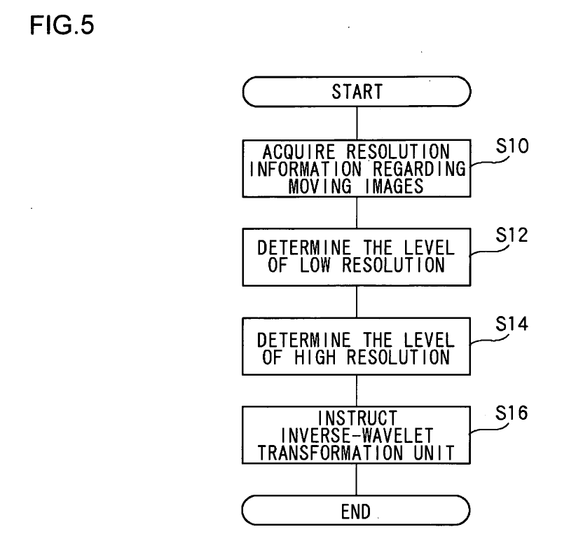

The image processing device 100 according to the embodiment has a feature for outputting the n-th level image to a low resolution frame buffer 30. The n-th level image is an intermediate decoded image obtained in inverse wavelet transformation performed by the inverse wavelet transformation unit 20. Furthermore, the image processing device 100 has a function for providing image data to both a low resolution display device 36 and a high resolution display device 46 with suitable resolutions. In order to realize such functions, the image processing device 100 includes a memory control unit 22. The memory control unit 22 acquires resolution information regarding the moving images which are to be displayed on the low resolution display device 36 and the high resolution display device 46. The memory control unit 22 determines the number of the times wherein the inverse wavelet transformation is to be performed for obtaining the images with suitable resolutions for each of the low resolution display device 36 and the high resolution display device 46. The memory control unit 22 finally transmits the determination results to the inverse wavelet transformation unit 20. The inverse wavelet transformation unit 20 writes the LL subband image of the n-th level image WIₙ which is an intermediate image obtained in the inverse wavelet transformation processing, or a completely decoded image data DI, to the low resolution frame buffer 30 and the high resolution frame buffer 40, according to the obtained information. Detailed description regarding this operation will be made later with reference to FIG. 5. Note that, while the aforementioned frame buffers are referred to as “low resolution frame buffer 30” and “high resolution frame buffer 40” for convenience of description, there is no need to employ buffers with different buffer sizes for the low resolution frame buffer 30 and the high resolution frame buffer 40.

The image data written in the low resolution frame buffer 30 is transformed into display signals by a low resolution display circuit 32, and the obtained signals are displayed on the low resolution display device 36. In the same way, the image data written in the high resolution frame buffer 40 is transformed into display signals by a high resolution display circuit 42, and the obtained display signals are displayed on the high resolution display device 46. As described above, the image processing device 100 has a function for displaying moving images on multiple display devices with different resolutions using the same coded image data stream at the same time.

One of or both of the low resolution display circuit 32 and the high resolution display circuit 42 have resolution converters 34 or 44. Such an arrangement allows conversion of the images with a desired resolution for each display device even in a case wherein the desired resolution for the display device 36 or 46 cannot be obtained by the inverse wavelet transformation performed by the decoding unit 150. Specifically, with such an arrangement, each image is decoded into an image of a suitable level having a resolution nearest to the desired resolution, and then the decoded image may be converted into an image with a desired resolution by the resolution converter 34 or 44. Note that these resolution converters 34 and 44 are optional units. Accordingly, an arrangement may be made wherein the low resolution display circuit 32 and the high resolution display circuit 42 do not include the resolution converters 34 and 44 if there is no need for displaying moving images with resolutions other than those obtained by the inverse wavelet transformation alone.

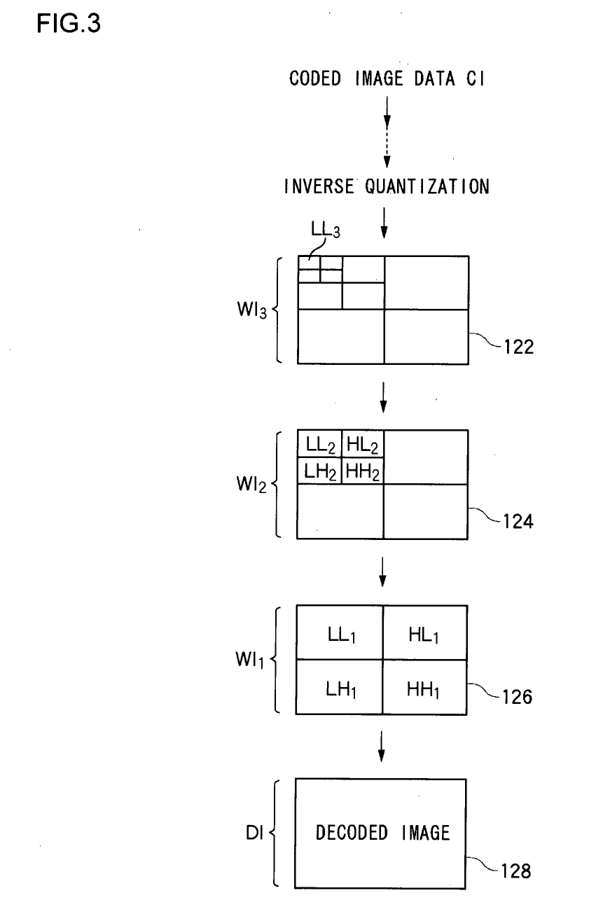

FIG. 3 shows a process performed by the decoding unit 150. Description will be made below regarding an example wherein the image processing device 100 receives a stream of coded image data obtained by performing triple wavelet transformation to the original image OI as described above.

First, the stream analysis unit 10, the arithmetical decoding unit 12, the bit plane decoding unit 14, and the inverse-quantization unit 18, perform predetermined image processing to the coded image data CI input to the image processing device 100, whereby the coded image data CI is decoded into the third-level image WI₃ 122. Subsequently, the inverse wavelet transformation unit 20 performs the first inverse wavelet transformation to the third level image WI₃ 122, thereby creating the second level image WI₂ 124. Then, the inverse wavelet transformation unit 20 further performs the second inverse wavelet transformation to the second-level image WI₂ 124, thereby creating the first level image WI₁ 126. In the final stage, the inverse wavelet transformation unit 20 further performs the third inverse wavelet transformation to the first-level image WI₁ 126, thereby creating the decoded image DI 128.

As described above, the LL subband image of each level is formed of low frequency components extracted from the corresponding level image, and is formed with quarter the image size of the immediately higher-level image. Accordingly, it can be understood that the LL subband image of each level is a low resolution image as compared with the original image OI. Giving consideration to the aforementioned fact, the LL₁ subband image (720×480) of the first level image WI₁ 126 obtained by double inverse wavelet transformation may be output as low resolution image data to the low resolution frame buffer 30, and the decoded image DI (1440×960) obtained by triple inverse wavelet transformation may be output as high resolution image data to the high resolution frame buffer 40, for example. As described above, an image is transformed with half the number of pixels in both X direction and Y direction for each wavelet transformation. Accordingly, the greater the number of times wherein the wavelet transformation is performed by the wavelet transformation unit of the image coding device, the greater number of resolutions are available for the image processing device 100 to select from for displaying moving images.

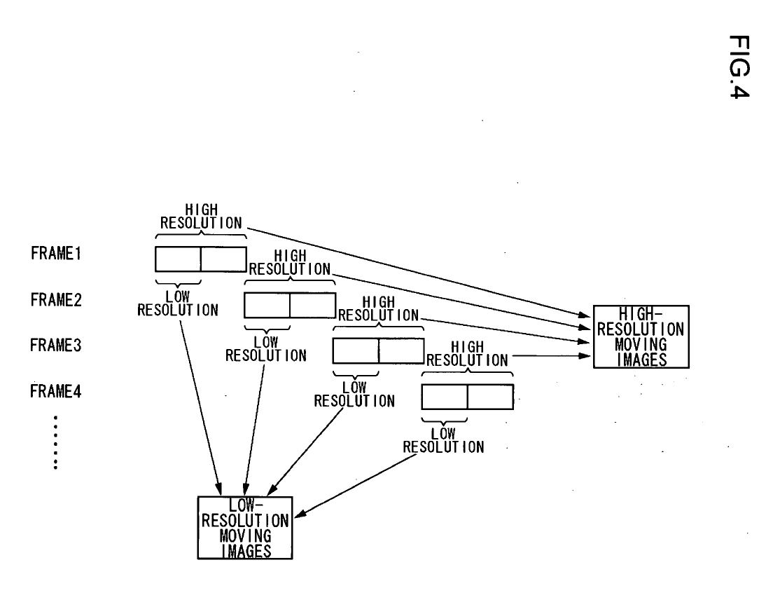

FIG. 4 is a schematic diagram for describing creation of moving images with different resolutions for each frame. The inverse wavelet transformation unit 20 performs necessary decoding process to each coded image frame so as to output a low resolution image to the low resolution frame buffer 30, as well as outputting a high resolution image to the high resolution frame buffer 40, according to instructions from the memory control unit 22. The low resolution images and the high resolution images are continuously output at a predetermined frame rate, thereby creating low resolution moving images and high resolution moving images from the same coded image data stream.

FIG. 5 is a flowchart for describing the operation of the memory control unit 22. First, the memory control unit 22 acquires information regarding the resolutions of the moving images which are to be displayed on the low resolution display device 36 and the high resolution display device 46 (S10). Alternatively, information regarding the resolutions of the moving images to be displayed for each display device may be input by the user. Next, the memory control unit 22 determines which level of the LL subband image transformed from the coded image CI is suitable for the low resolution image which is to be displayed on the low resolution display device 36 (S12). Subsequently, the memory control unit 22 determines which level of the LL subband image, or, the complete decoded image DI is suitable for the high resolution image which is to be displayed on the high resolution display device 46 (S14). Then, the memory control unit 22 instructs the inverse wavelet transformation unit 20 to write the subband image LL or the decoded image DI to the low resolution frame buffer 30 or the high resolution frame buffer 40 at the point that the image of the level determined in S12 or S14 has been obtained by the inverse wavelet transformation processing (S16). It is needless to say that, when only a single display device exists for receiving image data from the image processing device, one of the low resolution frame buffer 30 and the high resolution frame buffer 40 may be used.

As described above, with JPEG 2000, an LL subband image is created with half the numbers of pixels in the horizontal direction and the vertical direction of those of an original image for each wavelet transformation. Accordingly, in some cases, an LL subband image cannot be obtained with a resolution exactly matching that of the display device by inverse wavelet transformation alone. In order to handle such a situation, in the event that determination has been made in S12 or S14 that an LL subband image cannot be obtained with a suitable resolution by inverse wavelet transformation alone, the memory control unit 22 instructs the resolution converter 34 included in the low resolution display circuit 32 or the resolution converter 44 included in the high resolution display circuit 42 to perform interpolation processing for obtaining an image with a suitable resolution.

Also, the image processing device 100 may include three or more frame buffers for displaying moving images on three or more display devices with different resolutions. For example, assume that the image processing device 100 includes three frame buffers. The LL₂ subband image (360×240) of the second-level image WI₂ 124 obtained by single inversion wavelet transformation is output to a low resolution frame buffer. The LL₁ subband image (720×480) of the first level image WI₁ 126 obtained by double inversion wavelet transformation is output to an intermediate-resolution frame buffer. The decoded image DI 128 (1440×960) obtained by triple inversion wavelet transformation is output to a high resolution frame buffer. Thus, such an arrangement allows display of moving images on each display device with a low resolution, intermediate resolution, and high resolution, through the corresponding display circuits.

As described above, the image processing device according to the first embodiment may display moving images on two or more display devices with different resolutions at the same time using the same coded image data stream. Conventionally, the coded image data stream is decoded for each resolution required for displaying moving images. In contrast, according to the embodiment, an intermediate decoded image obtained in decoding process is output to a frame buffer, thereby allowing a single decoding unit to create multiple sets of moving images with different resolutions efficiently.

### Second Embodiment

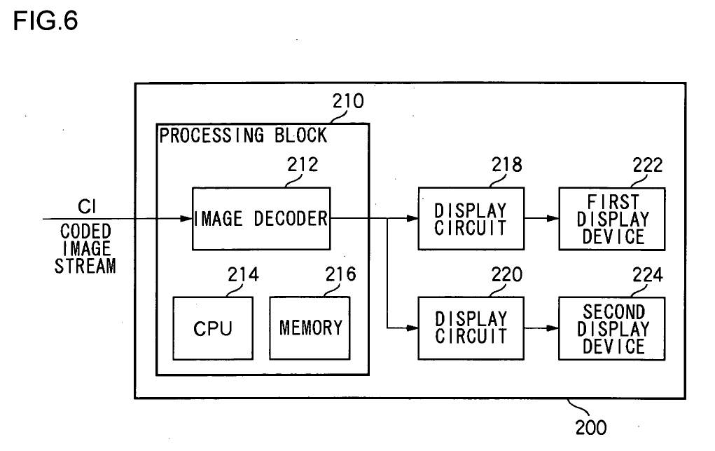

FIG. 6 shows a configuration of an image display device 200 according to a second embodiment. The image display device 200 includes a first display device 222 such as a display, projector, and so forth, for displaying high resolution moving images, and a second display device 224 for displaying low resolution moving images.

An image decoder 212 of a processing block 210 continuously decodes the received coded image data stream in cooperation with a CPU 214 and memory 216. Note that the image decoder 212 has the same configuration as with the image processing device 100 according to the first embodiment. With such a configuration, high resolution image data is output to the first display device 222 through a display circuit 218, and low resolution image data is output to the second display device 224 through a display circuit 220. Each display device continuously displays the image data, decoded by the image decoder 212, on the screen at a predetermined frame rate, whereby the moving images are reproduced. The processing block 210 may acquire the coded image data stream through a wired or wireless network communication interface, or through a reception block for receiving broadcast waves.

The image display device 200 may realize such operations as follows.

1. Movie System for Showing a Movie in a Cabin of an Airplane

The image display device 200 may be used in a movie system for showing a movie in a cabin of an airplane, which includes a large-size screen in front of the cabin of an airplane, and a small-size liquid display on the rear face of each seat for the passenger. The image display device 200 may display moving images on both the screen and the liquid displays by preparing a single kind of coded image data stream alone.

2. Presentation System

The image display device 200 may be used in a presentation system, which includes a PC screen and a large-size screen, which displays moving images projected from a projector. The image display device 200 may display moving images on both the large-size screen and the PC screen by preparing a single kind of coded image data stream alone.

3. Dual Screen Cellular Phone

The image display device 200 may be used in a dual screen cellular phone, which includes a main display and a sub-display. The image display device 200 may display moving video contents on both screens by preparing a single kind of coded image data stream that has been received.

Note that the image display device 200 may have three or more display devices for displaying moving images with different resolutions, depending upon the purpose of the device 200.

### Third Embodiment

According to a third embodiment of the invention, in response to user's instruct to improve image quality of a part of the image, the image processing device controls image processing so as not to exceed the maximum performance of the image processing device.

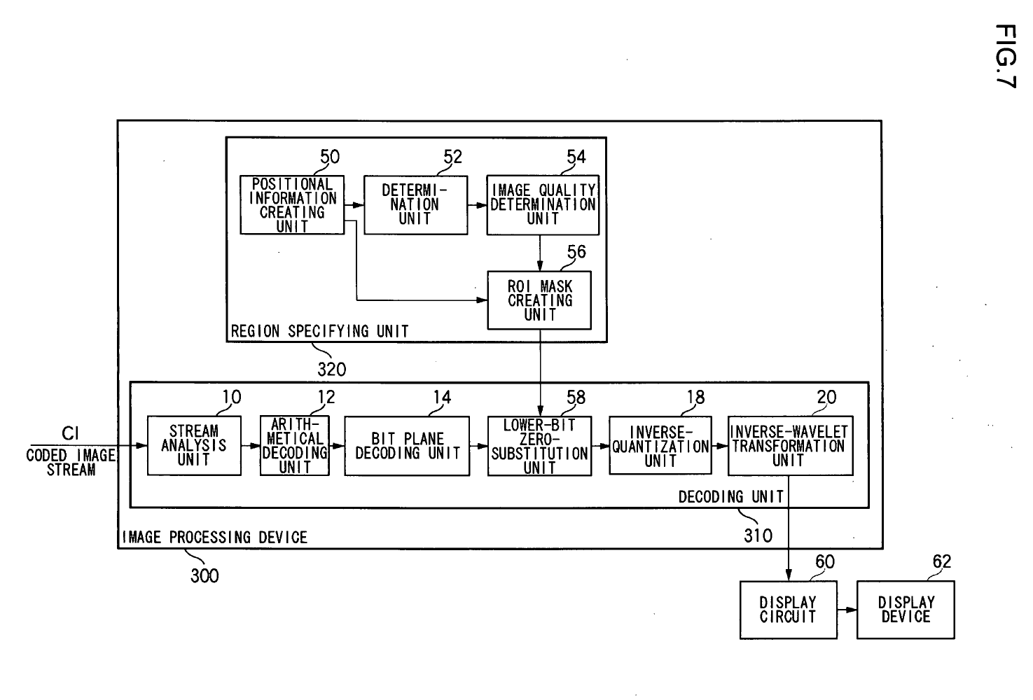

FIG. 7 is a diagram which shows a configuration of an image processing device 300 according to the third embodiment. The image processing device 300 includes: a decoding unit 310 for receiving a stream of the coded image data CI, and decoding the image; and a region specifying unit 320 for executing processing with regard to a region of interest in the image specified by the user. The decoding unit 310 includes the same components as described in the first embodiment, i.e., include the stream analysis unit 10, the arithmetical decoding unit 12, the bit plane decoding unit 14, the inverse-quantization unit 18, and the inverse-wavelet-transformation unit 20.

The image data decoded by the decoding unit 310 is displayed on a display device 62 through a display circuit 60. The image processing device 300 allows the user to specify a region which is to be reproduced with an improved image quality (which will be referred to as “ROI (Region of Interest)” hereafter) using an input device (not shown) such as a pointing device and so forth. Upon the user specifying the ROI, a positional information creating unit 50 within the region specifying unit 320 creates ROI positional information for indicating the position of the region of interest ROI. In case that the region of interest ROI is specified in the form of a rectangle, the ROI positional information consists of the coordinate position of the upperleft corner of the rectangular region, and the pixel numbers in the horizontal direction and the vertical direction thereof. On the other hand, in case that the user specifies the region of interest ROI in the form of a circle, the region specifying unit 320 may set the region of interest ROI to the circumscribing rectangle with regard to the circle thus specified. Note that the region of interest ROI may be always set to a predetermined region such as a region around the center of the original image.

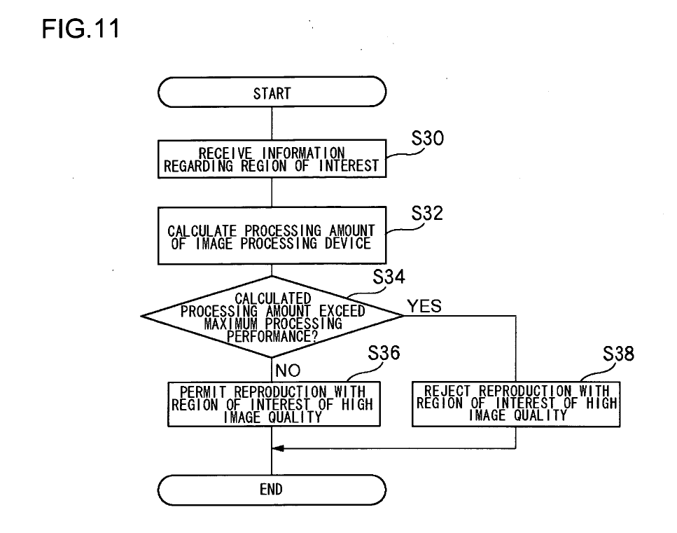

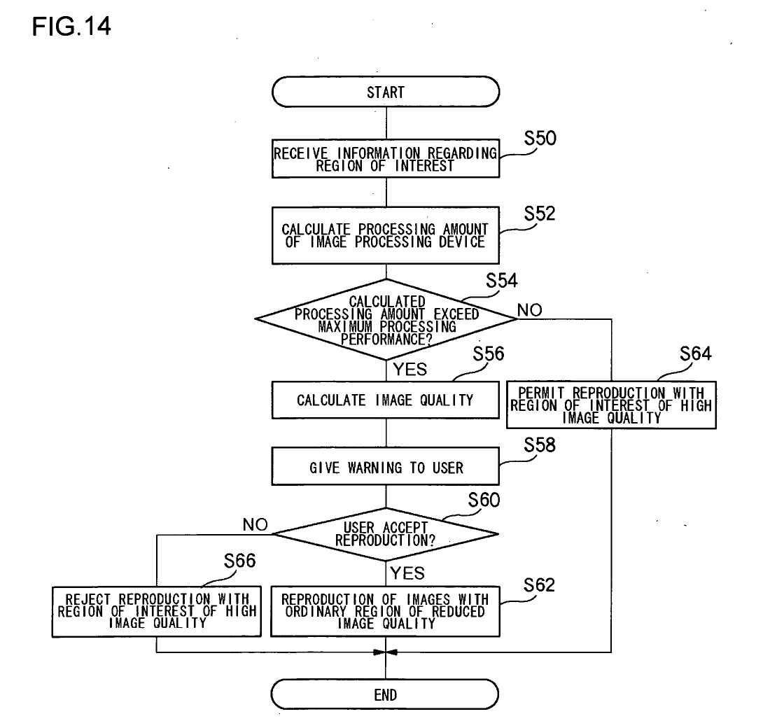

A determination unit 52 calculates an increase of the calculation amount of data processing necessary for improving image quality of the region of interest ROI based upon the ROI positional information thus created. The determination unit 52 determines whether or not the total decoding processing amount, which consists of the processing amount without improvement of the image quality of the ROI and the increase of the processing amount thus calculated, is within the maximum processing performance of the image processing device 300. An image quality determination unit 54 determines whether the image quality of the region of interest ROI is to be improved, or, the image in the region other than the region of interest ROI (which will be referred to as “ordinary region” hereafter) is reproduced with a lower image quality, based upon the determination results. The image quality determination unit 54 outputs the instructions thus determined to an ROI mask creating unit 56. Detailed description will be made later regarding the processing with reference to FIG. 11 or FIG. 14.

The ROI mask creating unit 56 creates an ROI mask for specifying the wavelet transformation coefficients in the regions corresponding to the region of interest ROI based upon the ROI positional information from the positional information creating unit 50. A lower-bit zero-substitution unit 58 sets predetermined lower bits of the bit sequence of the aforementioned wavelet transformation coefficient, to zero, using the ROI mask thus created. The image processing device 300 performs inverse wavelet transformation to the image subjected to the aforementioned lower-bit zero-substitution processing, thereby obtaining an image with the region of interest ROI of improved image quality. Detailed description will be made later.

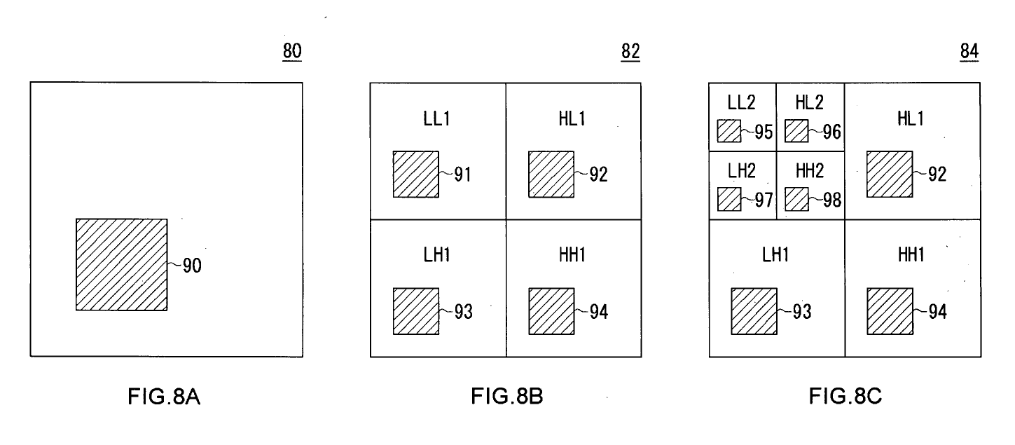

Now, description will be made regarding a method for creating the ROI mask by the ROI mask creating unit 56 based upon the ROI positional information with reference to FIGS. 8A through 8C. Assume that the user specifies a region of interest ROI 90 on an image 80 which has been decoded and displayed by the image processing device 300, as shown in FIG. 8A. The ROI mask creating unit 56 specifies a wavelet transformation coefficient for each subband image, required for reproducing the region of interest ROI 90 selected on the image 80.

FIG. 8B shows a transformation image 82 of a first level obtained by performing wavelet transformation to the image 80 once. The first level transformation image 82 consists of four first level subband images of LL₁, HL₁, LH₁, and HH₁. The ROI mask creating unit 56 specifies wavelet transformation coefficients (which will be referred to as “ROI transformation coefficients” hereafter) 91 through 94 in the first level subband images LL₁, HL₁, LH₁, and HH₁ of the first level transformation image 82 required for reproducing the region of interest ROI 90 of the image 80.

FIG. 8C shows a second-level transformation image 84 obtained by further performing wavelet transformation to the subband image LL₁ of the transformation image 82 shown in FIG. 8B. The second-level transformation image 84 includes four second-level subband images LL₂, HL₂, LH₂, and HH₂, in addition to the three first-level subband images HL₁, LH₁, and HH₁. The ROI mask creating unit 56 specifies wavelet transformation coefficients in the second-level transformation image 84 required for reproducing the ROI transformation coefficient 91 in the subband image LL₁ of the first level transformation image 82, i.e., the ROI transformation coefficients 95 through 98 in the second-level subband images LL₂, HL₂, LH₂, and HH₂.

In the same way, the ROI mask creating unit 56 specifies the ROI transformation coefficients corresponding to the region of interest ROI 90 for each level in a recursive manner the same number of times as that of the image 80 being subjected to wavelet transformation, thereby specifying all the ROI transformation coefficients in the transformation image in the final stage required for reproducing the region of interest ROI 90. That is to say, the ROI mask creating unit 56 creates an ROI mask for specifying the ROI transformation coefficients in the subband images of the transformation image in the final stage. For example, in a case wherein wavelet transformation has been performed for the image 80 two times, the ROI mask creating unit 56 creates an ROI mask for specifying the seven ROI transformation coefficients 92 through 98 indicated by hatched regions in FIG. 8C.

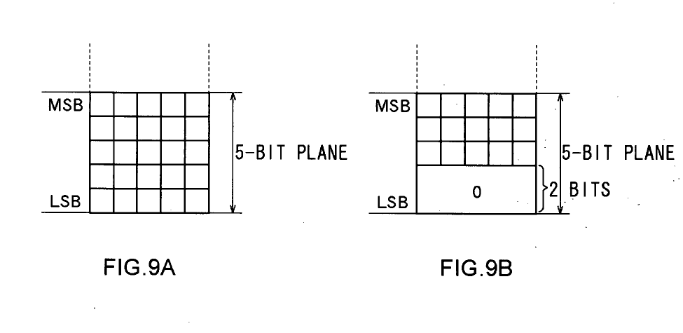

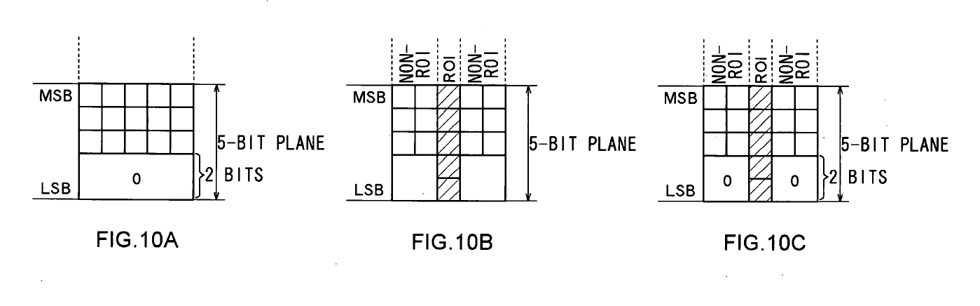

Next, description will be made regarding a method for improving the image quality of the region of interest ROI with reference to FIGS. 9 and 10. Now, assume that the coded image data CI consists of five-bit planes from the MSB (Most Significant Bit) plane to the LSB (Least Significant Bit) plane.

In normal operations wherein the user specifies no region of interest ROI, the image processing device 300 performs simple reproduction wherein images are reproduced without lower-bit planes with regard to the wavelet transformation coefficient, thereby enabling small-load processing. The image quality of the images thus reproduced will be referred to as “intermediate image quality” hereafter. In this case, the lower-bit zero-substitution unit 58 sets the lower two bits of the bit planes, decoded by the bit plane decoding unit 14, to zero, for example, thereby reproducing the images using three bit planes alone, as shown in FIG. 9B. Accordingly, in a case wherein the images are reproduced with the region of interest ROI of high image quality while maintaining the intermediate image quality of the other regions, the image processing device 300 performs decoding process to only the region of interest ROI with a greater number of bit planes while performing decoding process to the other region with an ordinary number of bit planes.

FIGS. 10A, 10B and 10C show an example of the processing for reproducing the images with the region of interest ROI of high image quality. At the time of the simple reproduction, the lower-bit zero-substitution unit 58 sets the lower two bits of the bit planes from the LSB plane, to zero, as shown in FIG. 10A. Upon the user specifying the region of interest ROI, the ROI mask creating unit 56 creates an ROI mask corresponding to the region of interest ROI. FIG. 10B shows the five-bit plane specified by the ROI mask indicated by a hatched region. The lower-bit zero-substitution unit 58 sets the lower two bits of the bit planes to zero in only the non-ROI region, i.e., in the region which has not been masked with the ROI mask, with reference to the ROI mask, for subsequent wavelet-transformation coefficient creating processing, as shown in FIG. 10C.

The inverse-quantization unit 18 performs inverse quantization to the wavelet transformation coefficients thus created. Subsequently, the inverse wavelet transformation unit 20 performs inverse wavelet transformation to the wavelet transformation coefficients subjected to inverse quantization, thereby obtaining image data with the region of interest ROI of high image quality while maintaining intermediate image quality of the other region.

Next, description will be made regarding processing performed by the determination unit 52 with reference to the flowchart shown in FIG. 11. Assume that, in normal operations wherein the user does not specify the region of interest ROI, the image processing device 300 displays moving images with intermediate image quality as described above.

First, the determination unit 52 receives the ROI positional information regarding the region of interest ROI from the positional information creating unit 50 (S30). Next, the determination unit 52 calculates the area (or the number of pixels) of the region of interest ROI based upon the ROI positional information so as to calculate the total decoding processing amount P which is to be performed by the image processing device 300 (S32).

Here, the decoding processing amount P can be obtained by calculating the aggregate sum of (processing amount per unit area required for reproducing the image with the image-quality level)×(the area where the image is to be reproduced with the image-quality level) with regard to the image-quality level. Suppose that the processing amount per unit area required for reproducing the image with low image quality is indicated as l_{L}, the processing amount per unit area required for reproducing the image with intermediate image quality as l_{M}, the processing amount per unit area required for reproducing the image with high image quality as l_{H}, and the area of the entire image as S, the decoding processing amount during normal usage is represented by Expression (1).
P=l_{M}·S (1)

In case that the user has specified the region of interest ROI with an area of s_{H} where the image is to be reproduced with high image quality, the decoding processing amount P is calculated by Expression (2).
P=l_{H}·s_{H}+l_{M}·(S−s_{H}) (2)

The determination unit 52 determines whether or not the decoding processing amount P thus calculated using Expression (2) exceeds the maximum processing performance Pₘₐₓ which is the maximum decoding performance of the image processing device 300 for each frame duration (S34). When determination has been made that the decoding processing amount P is equal to or smaller than the maximum processing performance Pₘₐₓ (in a case of “NO” in S34), the image quality determination unit 54 permits reproduction of images with the region of interest ROI of high image quality (S36). When the decoding processing amount P exceeds the maximum processing performance Pₘₐₓ (in a case of “YES” in S34), the image processing device 300 has no margin of processing performance for reproducing the image with the region of interest ROI of high image quality, and accordingly, the image quality determination unit 54 does not permit reproduction of images with the region of interest ROI of high image quality (S38).

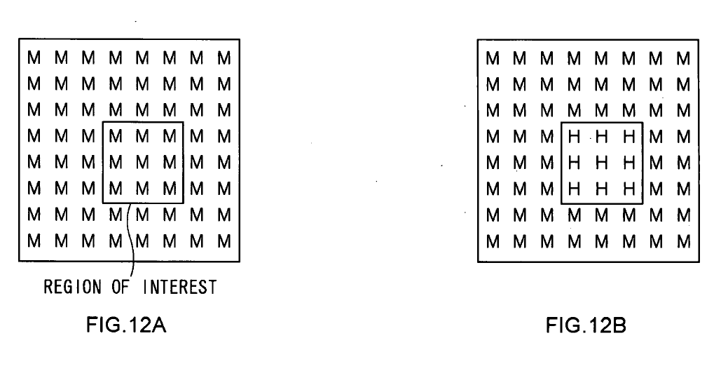

FIGS. 12A and 12B are schematic diagrams which show image processing in case that determination has been made that the decoding processing amount P is equal to or smaller than the maximum processing performance Pₘₐₓ in S34 in the flowchart shown in FIG. 11. In the drawing, the region with low image quality is denoted by “L”, the region with intermediate image quality is denoted by “M”, and the region with high image quality is denoted by “H”. Now, assume that the entire image is reproduced with intermediate image quality as shown in FIG. 12A. When the user specifies the region of interest ROI in the image, the image is reproduced with the region of interest ROI of high image quality (H) while maintaining the intermediate image quality (M) of the other region, as shown in FIG. 12B.

As described above, with the image processing device according to the embodiment, in response that the user specifies the region of interest ROI in the decoded and displayed images to be reproduced with high image quality, the image processing device reproduces images with the region of interest ROI of high image quality in case that the image processing device has a margin of the decoding processing performance. When determination has been made that the image processing device has no margin of decoding processing performance, the image processing device reproduces images without the region of interest ROI of high image quality.

When the region of interest ROI is specified, the image processing device reproduces images with the region of interest ROI of increased image quality while maintaining same image quality of the ordinary region with the simple reproduction. In particular, such an arrangement can be suitably applied to a surveillance monitor system which reproduces images with intermediate image quality in normal times, and reproduces images with the region of interest ROI of high image quality on detection of a predetermined situation.

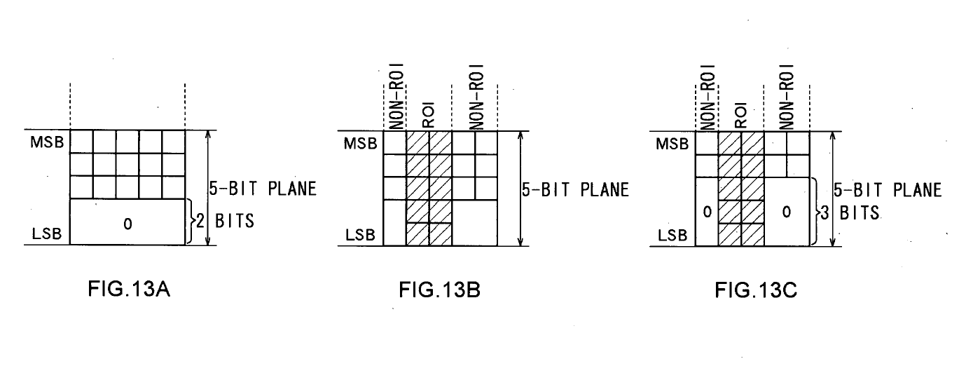

Next, description will be made regarding an example where the image processing device 300 has no margin for reproducing images with the region of interest ROI of high image quality, with reference to FIGS. 13A, 13B and 13C.

Assume that, at the time of simple reproduction, the lower-bit zero-substitution unit 58 sets the lower two bits of the bit planes to zero from the LSB plane, as shown in FIG. 13A. When the user specifies the region of interest ROI, the ROI mask creating unit 56 creates an ROI mask corresponding to the region of interest ROI. FIG. 13B shows the bit planes masked by the ROI mask, which is indicated by a hatched region. In this case shown in FIG. 13B, the image processing device 300 has no margin for reproducing images with the region of interest ROI of high image quality due to the increased area of the region of interest ROI as compared with a case shown in FIG. 10B. In such a situation, the lower-bit zero-substitution unit 58 refers to the ROI mask and sets the lower three bits (not the lower two bits) of the bit planes to zero in the non-ROI region, which has not been masked by the ROI mask, for creating the wavelet transformation coefficients.

The inverse-quantization unit 18 performs inverse quantization to the wavelet transformation coefficients thus created. Subsequently, the inverse wavelet transformation unit 20 performs inverse wavelet transformation to the wavelet transformation coefficients thus subjected to inverse quantization, thereby obtaining image data with the region of interest ROI of high image quality while reproducing images in the other region with low image quality. Thus, when the image processing device has no margin of processing performance for reproducing images with the region of interest ROI of high image quality (i.e., reproducing the images in the region of interest ROI using an increased number of bit planes), the image processing device reduces the number of the bit planes used for reproducing the images in the ordinary region for adjusting the total processing amount fewer than the maximum processing performance of the image processing device.

With reference to the flowchart shown in FIG. 14, description will be made regarding processing performed by the determination unit 52 when the image processing device 300 has no margin of processing performance for reproducing images with the region of interest ROI of high image quality. Assume that the user has not specified the region of interest ROI, moving images are displayed with intermediate image quality.

The determination unit 52 receives the region of interest ROI (S50), and calculates the total decoding processing amount P of the image processing device 300 (S52), which are the same processing as in S30 and S32 shown in FIG. 11. Subsequently, the determination unit 52 determines whether the decoding processing amount P calculated in S52 exceeds the maximum processing performance Pₘₐₓ of the image processing device 300 during one frame duration (S54). When the decoding processing amount P is equal to or smaller than the maximum processing performance Pₘₐₓ (“NO” in S54), the image quality determination unit 54 permits reproduction of images with the region of interest ROI of high image quality (S64).

When the decoding processing amount P exceeds the maximum processing performance Pₘₐₓ, the determination unit 52 calculates the processing amount l_{L} which satisfies the following Expression (3) for determining the image quality of the ordinary region (S56).
P=l_{H}·s_{H}+l_{L}·(S−s_{H}) (3)
Subsequently, the image quality determination unit 54 displays a notification prompting the user to determine whether or not images are to be reproduced with the region of interest ROI of high image quality while images in the ordinary region other than the region of interest ROI is reproduced with reduced image quality (S58). When the user determines that such processing is not to be performed (“NO” in S60), the image quality determination unit 54 does not permit reproduction of images with the region of interest ROI of high image quality (S66). When the user has determined that such processing is to be performed (“YES” in S60), the image quality determination unit 54 gives instructions so as to reproduce images with the region of interest ROI of high image quality while reproducing images in the ordinary region with low image quality (S62). This allows reproduction of images with the region of interest ROI of high image quality while maintaining the decoding processing amount P fewer than the maximum processing performance Pₘₐₓ.

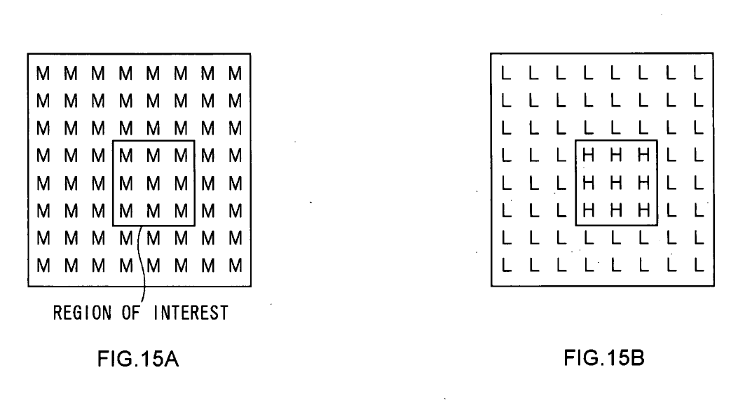

FIGS. 15A and 15B are schematic diagrams which show image processing when the user accepts reproducing images in the ordinary region other than the region of interest ROI with reduced image quality at S60 in the flowchart shown in FIG. 14. As shown in FIG. 15A, when the user specifies the region of interest ROI on the screen at the time of decoding of images with intermediate image quality (M), the image processing device reproduces images with the region of interest ROI with high image quality (H) while reproducing images in the other region with reduced image quality (L).

With the present embodiment, when the user specifies the region of interest ROI where the images are to be reproduced with high image quality, the image processing device reproduces images with the region of interest ROI of increased image quality, leading to the increased decoding processing amount for the region of interest ROI. At the same time, the image processing device reproduces images with the ordinary region other than the region of interest ROI of reduced image quality, thereby suppressing the total processing amount of the image processing device within the maximum processing performance thereof. This allows reproduction of images with the region of interest ROI specified by the user of high image quality without increasing the total processing amount of the image processing device. Furthermore, this allows reproduction of images without skipping frames due to increased decoding processing amount greater than the maximum processing performance of the image processing device.

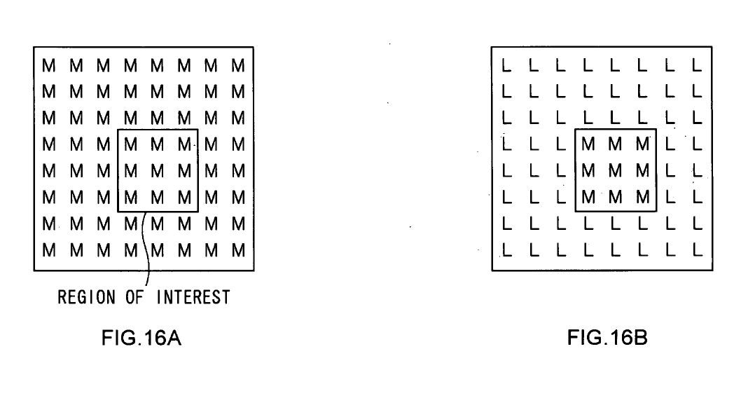

In alternative example, when the user specifies the region of interest ROI, the image processing device reproduces images with the region other than the region of interest ROI of reduced image quality while maintaining the intermediate image quality in the region of interest ROI. In this example, the lower-bit zero-substitution unit 58 sets the lower bits of the wavelet transformation coefficients corresponding to the non-ROI region to zero for decoding the image data with the region of interest ROI of relatively higher image quality than that of the ordinary region. FIGS. 16A and 16B show such processing. Assume that, in the normal usage state, the image processing device decodes the image data with intermediate image quality (M) in the entire region thereof as shown in FIG. 16A. When the user specifies the region of interest ROI on the screen, the image processing device reproduces images with the ordinary region of reduced image quality (L) while maintaining the intermediate image quality in the region of interest ROI as shown in FIG. 16B. The image processing device reproduces images with the region of interest ROI of relatively high image quality while reproducing images with reduced image quality in the other region, resulting in high evaluation of the image quality from the subjective view of the user.

While description has been made regarding an arrangement wherein the image processing device adjusts the image quality in a range of three image quality levels, i.e., “high level”, “intermediate level”, and “low level”, an arrangement may be made wherein the image processing device adjusts the image quality in a range of three or more image quality levels, depending upon the number of the lower bits which can be set to zero for adjustment of the image quality.

The user may specify multiple regions of interest ROIs. For example, when the user specifies the two regions of interest, the image quality determination unit 54 determines to reproduce images with one of the two region of interest of high image quality while maintaining the same image quality of the other region of interest depending upon the estimated necessary decoding processing amount. Instead of using instructions from the user, the positional information creating unit 50 automatically may set the region of interest ROI to an extracted important region such as a region including the image of a person, characters, or the like.

When the decoding processing amount P exceeds the maximum processing performance Pₘₐₓ, the image quality determination unit 54 instructs the decoding unit 310 to output moving images at a reduced frame rate. This reduces the decoding processing amount per unit time of the image processing device for reproducing the entire image, thereby allowing reproduction of images with the region of interest ROI of high image quality in spite of the reduction of the time resolution.

### Fourth Embodiment

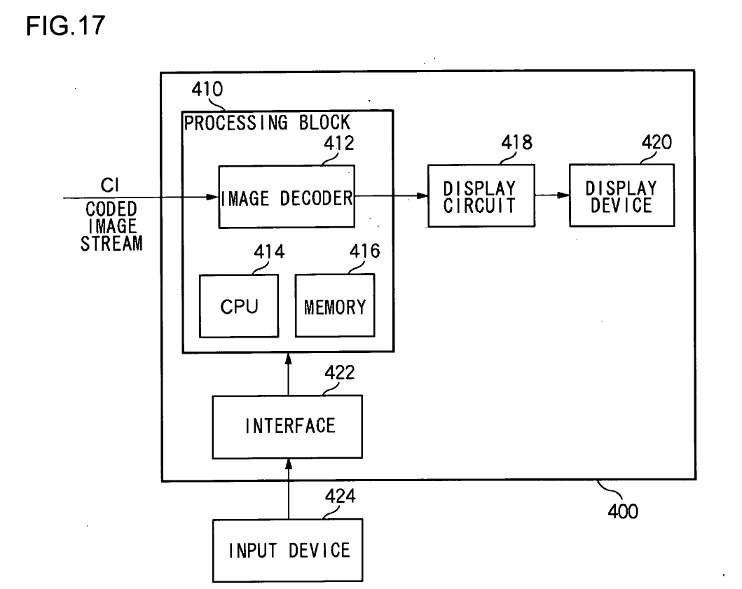

FIG. 17 is a configuration diagram which shows an image display device 400 according to a fourth embodiment. The image display device 400 has a function for displaying moving images on a display device such as a monitor. As an example, the image display device 400 may be employed as a display control device of a TV receiver, a surveillance camera, and so forth.

An image decoder 412 within a processing block 410 continuously decodes an input coded image data stream in cooperation with a CPU 414 and memory 416. The image decoder 412 has the same configuration as with the image processing device 300 according to the third embodiment. Note that the processing block 410 may acquire the coded image data stream through a wired or wireless network communication interface, or through a reception block for receiving broadcast waves.

A display circuit 418 receives the decoded images from the processing block 410, and outputs the decoded image to a display device 420. The display device 420 continuously displays decoded image frames, thereby reproducing moving images.

The image display device 400 has a configuration which allows the user to specify the region of interest ROI in the images displayed on the display device 420 using an input device 424 such as a pointing device, or using a display device which allows the user to input instructions by touching the screen. The information regarding the region of interest ROI is input to the processing block 410 through an interface 422. The processing block 410 receives the information regarding the region of interest ROI, and creates decoded images with the region of interest ROI of predetermined image quality.

According to the image display device 400, images captured by a surveillance camera with the region of interest ROI specified by the user may be reproduced in high image quality.

### Fifth Embodiment

A fifth embodiment according to the present invention relates to an image display device. The display device receives a coded image data stream multiplexed in regard to resolution, and continuously decodes the received coded image data stream for each frame. Then the display device provides moving images to a display device for displaying moving images with a low resolution, as well as to another display device for displaying moving images with a high resolution. According to the embodiment, when the user inputs instructions for increasing the image quality in a part of the image on one of the display devices, the image display device displays improves the image quality of the specified region on both the display device for displaying high resolution moving images and the display device for displaying low resolution moving images.

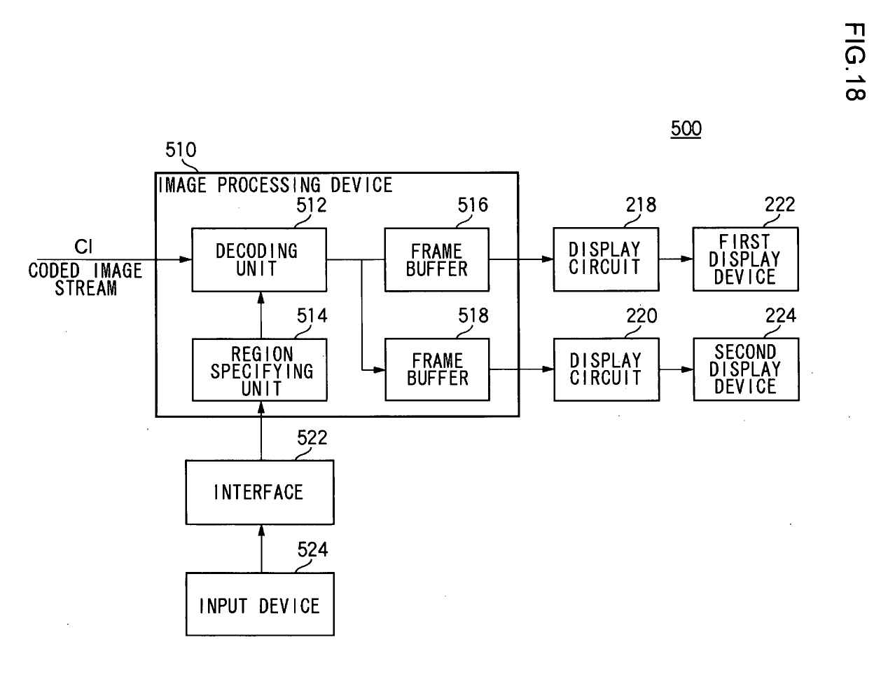

FIG. 18 shows a configuration of an image display system 500 according to the fifth embodiment. The image display system 500 includes the display circuits 218 and 220, and the first display device 222 and the second display device 224, which are the same components as in the second embodiment. Accordingly, these components are denoted by the same reference numerals as in the second embodiment. A decoding unit 512 and a region specifying unit 514 have the same configurations with the decoding unit 310 and the region specifying unit 320 according to the third embodiment shown in FIG. 7, respectively.

The decoding unit 512 of the image processing device 510 continuously decodes an input coded image data stream. Subsequently, high resolution image data is input to the first display device 222 for displaying high resolution moving images through a frame buffer 516 and the display circuit 218. Low resolution image data is input to the second display device 224 for displaying low resolution moving images through a frame buffer 518 and the display circuit 220. The processing is executed following the procedure described in the first embodiment. As a result, each of the first display device 222 and the second display device 224 continuously display decoded image data at a predetermined frame rate, thereby reproducing moving images. Note that the image processing device 510 may acquire a coded image data stream through a wired or wireless network communication interface, or through a reception block for receiving broadcast waves.

The user can specify the region of interest ROI in the images displayed on the first display device 222 or the second display device 224 using an input device 524 such as a pointing device. The user also can input instructions by touching the screen, such as a touch panel. The information regarding the region of interest ROI is input to the image processing device 510 through an interface 522. The region specifying unit 514 receives the information regarding the region of interest ROI, and determines whether the images are to be reproduced with the region of interest ROI of high image quality, and transmits the determination results to the decoding unit 512. According to the determination results, the decoding unit 512 creates high resolution image data and low resolution image data with the region of interest of predetermined image quality. Note such the processing is executed following the procedure described in the third embodiment. Finally, each of the first display device 222 and the second display device 224 reproduce moving images in the same way as described above.

According to the embodiment, when multiple sets of moving images with different resolution are displayed on multiple display devices, the image quality in the region of interest for all the display devices is improved in response to the user's specifying the region of interest. For example, the present embodiment is suitably applied to a presentation system which displays moving images on both a large-size screen projected from a projector and a PC screen. When the user specifies the ROI on the PC, then the quality of the ROI in the screen becomes high. Thus, the user can emphasize the image to audience efficiently. Also, the present embodiment is suitably applied to a surveillance camera system. The system displays the same surveillance image stream on multiple displays in multiple monitor rooms. Such a surveillance camera system according to the present embodiment allows the user to call the attention of other monitor staff to the region of the image specified by the user.

Note that the image display system 500 may include three or more display devices for displaying moving images with different resolutions.

As described above, description has been made regarding the present invention with reference to the aforementioned embodiments. The above-described embodiments have been described for exemplary purposes only, and are by no means intended to be interpreted restrictively. Rather, it can be readily conceived by those skilled in this art that various modifications may be made by making various combinations of the aforementioned components or the aforementioned processing, which are also encompassed in the technical scope of the present invention.

Instead of using wavelet transformation, other spatial frequency transformation may be employed as spatial filtering for coding an image in all the embodiments. For example, discrete cosine transformation employed in JPEG standard may be employed as spatial filtering for coding an image. Such an arrangement also has the same function for reproducing images with the region of interest of relatively high image quality while reproducing images in the ordinary region with relatively low image quality by setting the lower bits of the transformation coefficients in the ordinary region to zero. Thus, such an arrangement has the same advantage of reproducing images with the region of interest of high image quality while suppressing the total processing amount of the image processing device.

1. An image processing device wherein a decoding unit decodes coded image data so as to create multiple sets of moving images with different resolutions for displaying said moving images on a plurality of display devices.

2. The image processing device according to claim 1, which creates moving images with a lower resolution than that of completely decoded images, using intermediate images obtained in a decoding step for decoding said coded image data.

3. An image processing device comprising:
a decoding unit for decoding coded image data;
a low resolution frame buffer for storing low resolution image-data output from said decoding unit;
a high resolution frame buffer for storing high resolution image data output from said decoding unit;
a low resolution display circuit for acquiring data from said low resolution frame buffer, and creating display signals for a low resolution display device; and
a high resolution display circuit for acquiring data from said high resolution frame buffer, and creating display signals for a high resolution display device.

4. The image processing device according to claim 3, wherein said coded image data is multiplexed in such a manner to have a plurality of resolution levels,
said decoding unit creates multiple sets of image data with various resolution levels in the decoding process for decoding said coded image data.

5. The image processing device according to claim 4, further comprising a memory control unit for controlling data writing to said low resolution frame buffer and said high resolution frame buffer,
wherein said memory control unit controls each of said low resolution frame buffer and said high resolution frame buffer to store images with the corresponding resolution, the images being created by decoding said coded image data.

6. The image processing device according to claim 5, wherein said memory control unit acquires resolution information regarding images to be displayed on a display device, and selects a level having a resolution nearest to the resolution thus acquired,
said decoding unit writes images to said low resolution frame buffer and said high resolution frame buffer, said images written to each frame buffer being created in a level selected by said memory control unit.

7. The image processing device according to claim 6, wherein at least one of said low resolution display circuit and said high resolution display circuit has a converter for performing resolution conversion.

8. The image processing device according to claim 3, wherein said decoding unit is a single unit.

9. An image processing method, comprising:
decoding coded image data by a decoding unit;
extracting multiple sets of images with various resolutions from the decoded data; and
outputting said multiple sets of images to multiple display means through corresponding path.

10. The image processing method according to claim 9, further comprising creating moving images with a lower resolution than that of completely decoded images using intermediate images obtained in said decoding step for decoding said coded image data.

11. An image processing method, comprising:
creating multiple sets of image data with various levels in a decoding process for decoding coded image data multiplexed in such a manner to have a plurality of resolution levels;
storing low resolution image data created in said creating step in a low resolution frame buffer;
storing high resolution image data created in said creating step in a high resolution frame buffer;
acquiring image data from said low resolution frame buffer to create display signals for a low resolution display device; and
acquiring image data from said high resolution frame buffer to create display signals for a high resolution display device.

12. The image processing method according to claim 11, further comprising:
acquiring resolution information regarding images to be displayed on each display device;
selecting a level having a resolution nearest to the resolution acquired for each display device; and
instructing each of said low resolution frame buffer and said high resolution frame buffer to store the images created in said selecting corresponding level.

13. The image processing method according to claim 12, further comprising performing resolution conversion processing to image data written to said low resolution frame buffer or said high resolution frame buffer.

14. The image processing method according to claim 9, wherein said decoding unit is a single unit.

15. An image processing device comprising:
a decoding unit for decoding coded image data so as to create multiple sets of moving images with various resolutions for displaying said moving images on a plurality of display devices; and
a region specifying unit for specifying region of interest on a screen,
wherein said decoding unit decodes images having said region of interest with image quality different from that of an ordinary region other than said region of interest.
